(19) United States
(12) Patent Application Publication
(10) Pub. No.: US 2010/0157605 A1
(43) Pub. Date: Jun. 24, 2010

(54) LIGHT EMITTING DIODE LAMP

(75) Inventors: CHIA-SHOU CHANG, Tu-Cheng (TW); LIN YANG, Shenzhen City (CN); JER-HAUR KUO, Tu-Cheng (TW); SHUN-YUAN JAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen (CN); FOXCONN TECHNOLOGY CO., LTD., Tu-Cheng (TW)

(21) Appl. No.: 12/465,659

(22) Filed: May 14, 2009

(30) Foreign Application Priority Data
Dec. 23, 2008 (CN) 200810306474.3

(51) Int. Cl. F21V 29/00; F21V 7/08

(52) U.S. Cl. 362/294; 362/296.06

(57) ABSTRACT

A light emitting diode lamp includes a lampshade and a light source. The lampshade is a portion of a hollow ellipsoid with one focus of the ellipsoid located therein. The lampshade is symmetric to a major axis of the ellipsoid. The lampshade has a vertex located on the major axis and defines a light extraction opening at one end thereof opposite to the vertex. A reflecting layer is formed on an inner surface of the lampshade. The light source is received in the lampshade and localized at the one focus of the ellipsoid. The light source includes a plurality of light emitting diodes facing the inner surface of the lampshade and the light extraction opening, respectively.

### BACKGROUND

1. Technical Field

The present disclosure relates to light emitting diodes, and more particularly to a light emitting diode lamp.

2. Description of Related Art

With the continuing development of scientific technology, light emitting diodes (LEDs) have been widely used in the illumination field due to their high brightness, long life-span, and wide color gamut.

A conventional LED lamp includes a lampshade and a light source received in the lampshade. The lampshade is bowl-shaped and has smooth inner surface. A reflecting layer is formed on the inner surface of the lampshade.

In operation of the LED lamp, lights emitted from the LED chips shoot towards the inner surface of lampshade and are refracted by the reflecting layer, and then spread out of the LED lamp via an opening of the lampshade. Since the lights are refracted by the reflecting layer, whose smooth nature can not help the emitted lights to be concentrated to a smaller area to satisfy a high-brightness requirement, or can not help the emitted light to be dispersed to a larger area to satisfy a large-area illumination requirement.

For the foregoing reasons, therefore, there is a need in the art for a light emitting diode lamp which overcomes the above-mentioned problems.

### BRIEF DESCRIPTION OF THE DRAWINGS

FIG. 1 is a schematic view showing properties of an ellipse.

FIG. 2 is an exploded view of a light emitting diode lamp in accordance with a first embodiment.

FIG.3 is an assembled view of the light emitting diode lamp of FIG. 2.

FIG. 4 is an exploded view of a light emitting diode lamp in accordance with a second embodiment.

FIG. 5 is a cross-section of the light emitting diode lamp of FIG. 4.

### DETAILED DESCRIPTION

Reference will now be made to the drawing figures to describe the present heat dissipation device in detail.

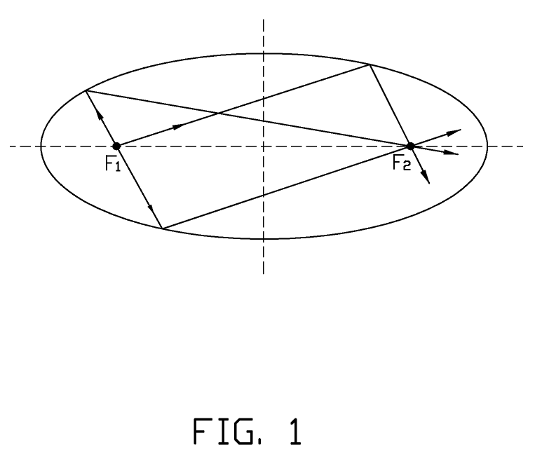

FIG. 1 illuminates properties of an ellipsoid. The ellipsoid defines two foci F₁, F₂. It is known that waves, such as light or sound, from one focus F₁ (F₂) are reflected by inner surface of the ellipsoid, and then pass through the other focus F₂ (F₁).

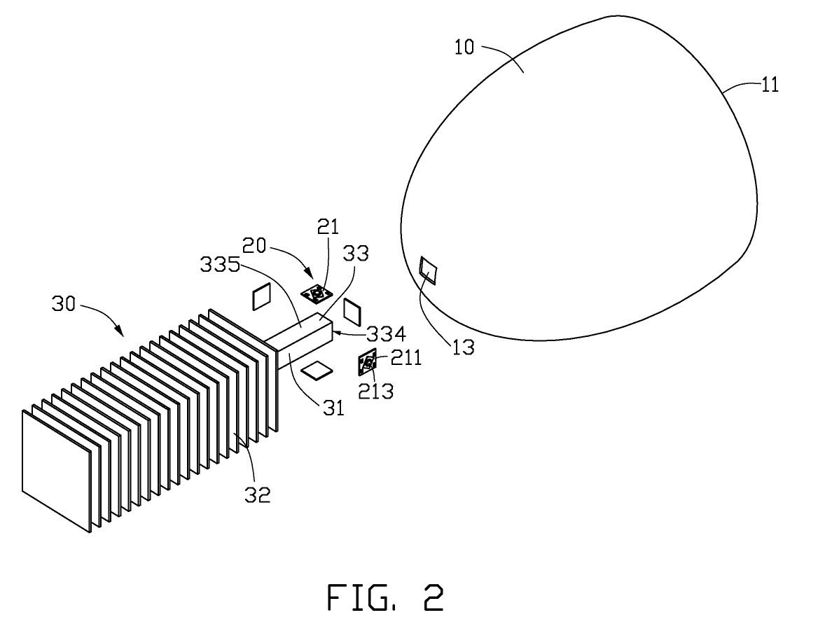

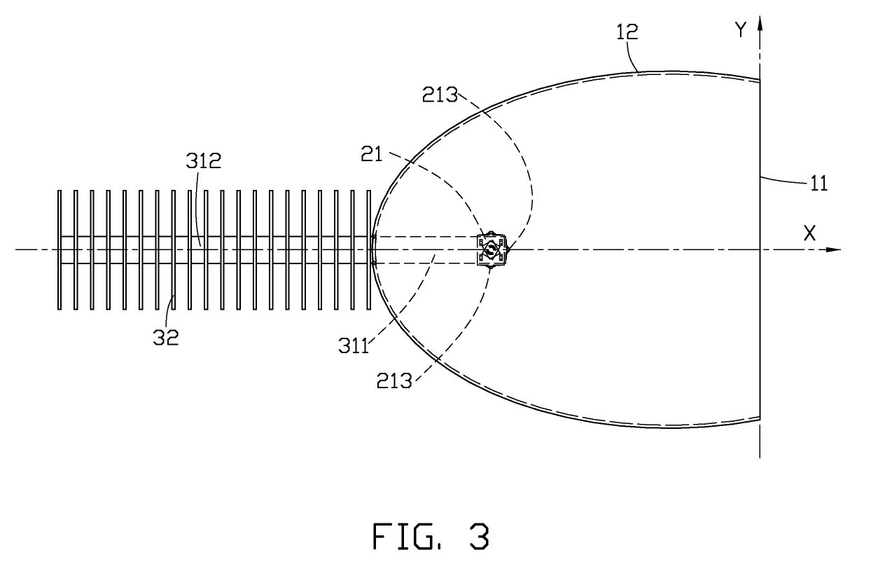

Referring to FIGS. 2 and 3, a light emitting diode (LED) lamp in accordance with the disclosure is shown. The LED lamp includes a lampshade 10, a light source 20 received in the lampshade 10 and a heat sink 30 for dissipation heat from the light source 20.

The lampshade 10 is a portion of an imaginary hollow ellipsoid, which is formed by rotates a portion of an ellipse around an major axis X of the ellipse. In other words, the lampshade 10 is symmetric to the major axis X of the imaginary ellipsoid. In this embodiment, the lampshade 10 is a semi-ellipsoid shaped shell, and expands rightward along the major axis X. A vertex is formed at a front side of the lampshade 10. A mounting hole 13 is defined at the vertex of the lampshade 10. A light extraction opening 11 is defined at a rear side of the lampshade 10 perpendicular to the major axis X. The opening 11 is circular with a diameter equaling to a length of a minor axis Y of the imaginary ellipsoid. That is, the mounting hole 13 and the light extraction opening 11 are defined at two opposite ends of the lampshade 10, respectively, along the major axis X of the imaginary ellipsoid. A reflecting layer 12 is formed on an inner surface of lampshade 10. The reflecting layer 12 is made of highly reflective materials, such as metal, white printing ink, etc. While, here, the reflecting layer 12 is an aluminum film applied on the inner surface of the lampshade 10.

The light source 20 includes a plurality of LEDs 21. In this embodiment, the light source 20 includes five LEDs 21, i.e., a front LED 21, a left LED 21, a right LED 21, a top LED 21 and a bottom LED 21. Each of the LEDs 21 includes a printed circuit board 211 and a LED chip 213 mounted on the printed circuit board 211. Each of the LED chips 213 electrically connects the printed circuit boards 211 via metal electrodes thereof.

The heat sink 30 is made of a highly thermally conductive material, such as aluminum, copper or their alloys. The heat sink 30 includes a thermal pole 31 and a plurality of fins 32. The thermal pole 31 has a rectangular cross-section. The thermal pole 31 includes a heat absorbing section 311 located inside the lampshade 10 and a heat dissipation section 312 protruding out of the lampshade 10 through the mounting hole 13. The five LEDs 21 are located at an end surface 334 and four sides 335, i.e., a top side 335, a bottom side 335, a left side 335 and a right side 335, of a distal end 33 of the heat absorbing section 311, respectively, adjacent to the end surface 334. Thus, the front LED arranged on the end surface 334 of the distal end 33 faces the light extraction opening 11 of the lampshade 10, and the other four LEDs 21 face left, right, top and bottom portions of the inner surface of the lampshade 10, respectively. Thus, the distal end 33 of the heat absorbing section 311 of the thermal pole 31 functions as a supporter for supporting the light source 20 thereon. The light source 20 is formed as a three-dimensional light source which has a plurality of angled light extraction surfaces each including a portion of lights emitted therefrom. The fins 32 are stacked along the heat dissipation section 312 of the thermal pole 31, being paralleled to and spaced from each other. Each fin 32 is substantially square, and defines an aperture at a central portion thereof for extension of the heat dissipation section 312 of the thermal pole 31 therethrough.

A length of the heat absorbing section 311 of the thermal pole 31 substantially equals to a distance between the vertex and a front focus of the imaginary ellipsoid adjacent to the vertex of the lampshade 10. Therefore, the distal end 33 of the heat absorbing section 311 is substantially located at the front focus of the lampshade 10.

In operation of the LED lamp, a portion of the lights emitted from the light source 20 irradiates towards the light extracting opening 11 and exits therefrom directly, and the other portion of the lights emitted from the light source 20 irradiates towards the inner surface of the lampshade 10, is reflected by the reflecting layer 12 and finally exits the LED lamp from the light extracting opening 11. Due to the optical properties of ellipsoid illustrated in FIG. 1, the other portion of the lights of the light source 20 which is reflected by the inner surface of the lampshade 10 will influx at a rear focus which is far away from the vertex of the imaginary ellipsoid, and finally irradiates therefrom with different directions.

More specifically, most of the lights of the top LED 21 of the light source 20 firstly shoots towards the top portion of the inner surface of the lampshade 10, and is reflected by the reflecting layer 12 on the top portion of the inner surface of the lampshade 10 to the rear focus, and finally leaves from the rear focus downwardly towards a lower side of the rear focus. Meanwhile, a minor portion of the lights from the top LED 21 firstly shoots towards the top portion of the inner surface of the lampshade 10, and is multi-reflected by the reflecting layer 12 to the rear focus, and finally leaves from the rear focus randomly with different directions. Similarly, most of the lights from the bottom LED 21 shoots upwardly towards an upper side of the rear focus after passed through the rear focus, and a minor portion of the lights from the bottom LED 21 leaves from the rear focus randomly; most of the lights from the left and the right LEDs 21 shoots towards a right side and a left side of the rear focus, respectively, and a minor portion of the lights of each of the left and the right LEDs 21 leaves from the rear focus randomly. Distinguishably, most of the lights emitted from the front LED 21 exits from the LED lamp via the light extracting opening 11 directly and approximately parallel. Meanwhile, a portion of the lights emitted from the front LED 21 irradiates on an edge portion, which is adjacent to the light extraction opening 11, of the inner surface of the lampshade 10, and is reflected towards the rear focus, and finally leaves from the rear focus radially. Thus, the lights from the different LEDs 21 have a chance to be combined and mixed, and cooperatively form an illumination region having a high light intensity and a good uniformity.

In the present LED lamp, the lights incident on the inner surface of the lampshade 10 are refracted by the reflecting layer 12 and then change their original directions to traverse through the rear focus of the imaginary ellipsoid, whereby the LED lamp can be used to concentrate or disperse the lights generated by the light source 20 by changing a ratio between the major axis X and the minor axis Y of the imaginary ellipsoid. When the ratio is decreased, the rear focus is closer to the front focus; therefore, the lights emitted from the light source 20 can be dispersed to a larger illumination region than the conventional light emitting diode lamp. Contrarily, when the ratio is increased, the rear focus is farther way from the front focus; therefore, the lights emitted from the light source 20 can be concentrated to a smaller illumination region than the conventional LED lamp, thus satisfying a pointing, indicating or spotting requirement. Furthermore, the light source 20 includes the plurality of angled light extraction surfaces facing different portions of the inner surface of the semi-ellipsoid shaped lampshade 10, which makes the LED lamp work like a scale-like reflecting surface arranged on a smooth inner surface of the lampshade 10 to provide sufficient brightness of proper intensity and uniformity, whereby a soft lighting environment for comfortable conditions can be obtained.

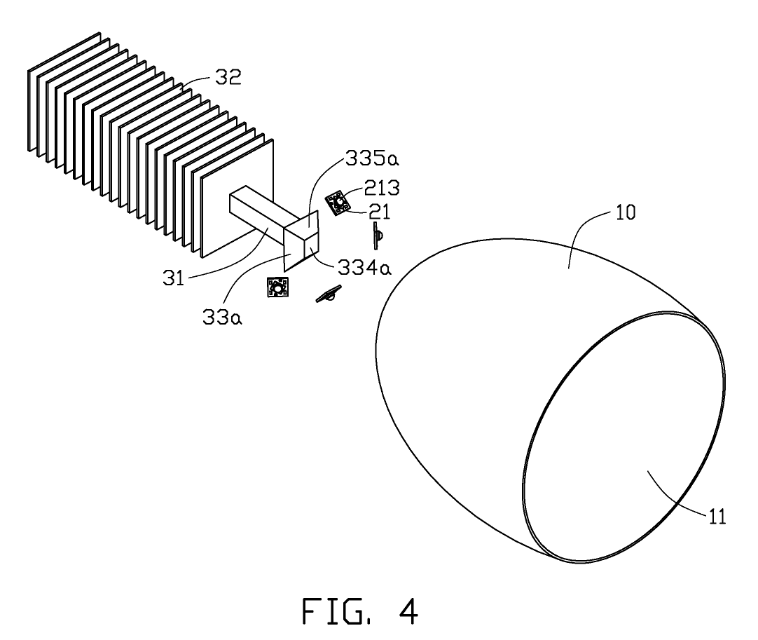

FIG. 4 is an exploded view of a LED lamp in accordance with a second embodiment of the disclosure, differing from the previous LED lamp only in that a separately molded supporter 33a is provided. The supporter 33a is affixed to the distal end 33 of the heat absorbing section 311 of the thermal pole 31, and localized at the front focus of the lampshade 10. The supporter 33a is a quadrangular prismoid. A rear surface 334a of the supporter 33a faces the light extraction opening 11 of the lampshade 10. The light source 20 includes four LEDs 21 arranged on four lateral surfaces 335a of the supporter 33a, respectively.

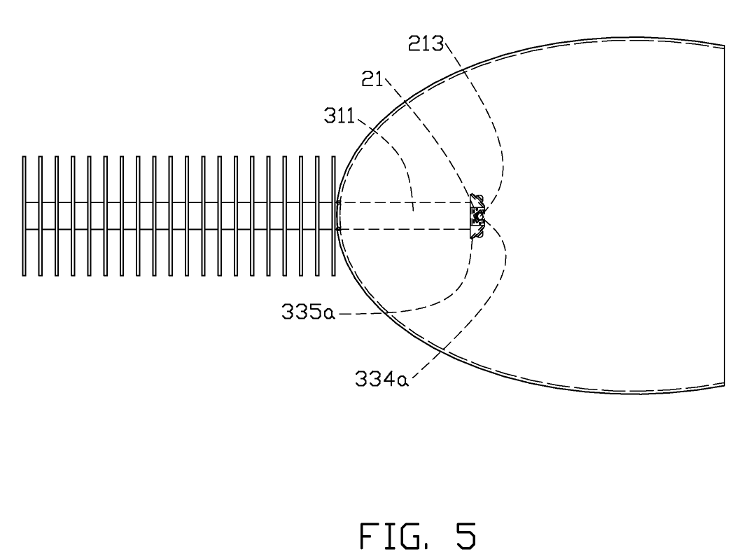

Referring to FIG. 5 together, an acute angle of 45 degrees is formed between each of the lateral surfaces 335a and the rear surface 334a of the supporter 33a. For the lateral surfaces 335a inclined with the acute angle formed relative to the rear surface 334a which faces and is parallel to the light extracting opening 11, the LED chips 213 located on the lateral surfaces 335a are inclined to the light extracting opening 11 as well. Thus, a part of the lights from each of the LED chips 213 can irradiate towards the light extracting opening 11 and exit therefrom directly, thereby achieving a higher light intensity and a better uniformity. The other part of the lights from each of the LED chips 213 mainly shoots towards an edged portion, which is adjacent to the light extraction opening 11, of the inner surface of the lampshade 10; as a result, a total internal reflection of the lights which incidents on the inner surface of the lampshade 10 for multi-reflection is reduced, and accordingly the extracting rate of the lights from the light extraction opening 11 of the LED lamp is increased. The other part of the lights irradiates on the inner surface of the lampshade 10 can be effectively reflected by the reflecting layer 12 to the rear focus, and cooperatively forms a circular illumination region of the LED lamp.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light emitting diode lamp comprising:
a lampshade being a portion of a hollow ellipsoid with one focus of the ellipsoid located therein, the lampshade being symmetric to a major axis of the ellipsoid, the lampshade having a vertex located on the major axis and defining a light extraction opening at one end thereof opposite to the vertex, a reflecting layer being formed on an inner surface of the lampshade; and
a light source being received in the lampshade and localized at the one focus of the ellipsoid, the light source comprising a plurality of light emitting diodes facing the inner surface of the lampshade and the light extraction opening respectively.

2. The light emitting diode lamp of claim 1, wherein the lampshade is a semi-ellipsoid shaped shell, the light extracting opening being defined along a minor axis of the ellipsoid and perpendicular to the major axis.

3. The light emitting diode lamp of claim 1, further comprising a supporter providing a plurality of angled supporting surfaces for mounting the light emitting diodes thereon respectively.

4. The light emitting diode lamp of claim 3, further comprising a thermal pole, the lampshade defining a mounting hole at the vertex, the thermal pole comprising a heat absorbing section traversing through the mounting hole and extending to the one focus and a heat dissipation section protruding out of the lampshade, a distal end of the heat absorbing section forming the supporter.

5. The light emitting diode lamp of claim 4, wherein the supporter has a rectangular cross-section, the supporter comprising an end surface facing the light extraction opening and four lateral sides adjacent and perpendicular to the end surface.

6. The light emitting diode lamp of claim 4, wherein a plurality of fins extend outwardly from the heat dissipation section.

7. The light emitting diode lamp of claim 3, further comprising a thermal pole, the lampshade defining a mounting hole at the vertex, the thermal pole comprising a heat absorbing section traversing through the mounting hole and extending to the one focus and a heat dissipation section protruding out of the lampshade, the supporter being affixed to the thermal pole.

8. The light emitting diode lamp of claim 7, wherein the supporter is a quadrangular prismoid, the supporter comprising a rear surface facing the light extraction opening and four lateral sides adjacent and angled with the rear surface.

9. The light emitting diode lamp of claim 7, wherein a plurality of fins are formed on the heat dissipation section.

10. The light emitting diode lamp of claim 1, wherein the light source comprises a plurality of angled light extraction surfaces each of which has a portion of lights emitted from the light source.
